(19) United States
(12) Patent Application Publication
(10) Pub. No.: US 2021/0266289 A1
(43) Pub. Date: Aug. 26, 2021

(54) SECURED CONTAINER MANAGEMENT

(71) Applicants: David Maw, Irvine, CA (US); Robert A Johnson, Collegeville, PA (US); Alex Dorrell, Blue Bell, PA (US); Arthur J Nilson, Blue Bell, PA (US)

(72) Inventors: David Maw, Irvine, CA (US); Robert A Johnson, Collegeville, PA (US); Alex Dorrell, Blue Bell, PA (US); Arthur J Nilson, Blue Bell, PA (US)

(73) Assignee: Unisys Corporation, Blue Bell, PA (US)

(21) Appl. No.: 16/797,756

(22) Filed: Feb. 21, 2020

(51) Int. Cl. H04L 29/06; G06F 21/62

(52) U.S. Cl. CPC H04L 63/0209; H04L 63/0428; G06F 21/6218

(57) ABSTRACT

A method of securing containers within clusters is disclosed. The method includes configuring service access points within clusters as secure endpoints; associating services within clusters with secure identities to constrain which communities-of-interest can reach which services; and wherein each cluster is cryptographically isolated such that no information will leak in or out of the cluster through an associated network.

### FIELD OF THE DISCLOSURE

The present application relates generally to secured containers, and more particularly to securing containers within clusters through the use of secured endpoints.

### BACKGROUND

In the past, organizations ran applications on physical servers. There was no way to define resource boundaries for applications in a physical server, and this caused resource allocation issues. For example, if multiple applications run on a physical server, there can be instances where one application would take up most of the resources, and as a result, the other applications would underperform. A solution for this was to run each application on a different physical server. But this did not scale as resources were underutilized, and it was expensive for organizations to maintain numerous physical servers.

One solution has been the use of virtual machines. Virtualization allows one to run multiple virtual machines on a single physical servicer's CPU. Virtualization allows applications to be isolated between virtual machines and provides a level of security as the information of one application cannot be freely accessed by another application. Virtualization allows better utilization of resources in a physical server and allows better scalability because an application can be added or updated easily. With Virtualization, a set of physical resources can be presented as a cluster of disposable virtual machines. Each virtual machine is a full machine running all the components, including its own operating system on top of the virtualized hardware. In a conventional solution, a network may include a plurality of servers hosting virtual machines leased by tenants. The virtual machines may start and stop based on demand for the tenant's services. However, virtual machines running in a cloud are not well protected from other machines in the cloud or from devices with physical access to the cloud.

Containers are similar to virtual machines, but they have relaxed isolation properties because they share a common Operating System among the applications. Similar to a virtual machine, a container has its own filesystem, CPU, memory, process space and more. Because they are decoupled from the underlying infrastructure, they are portable across clouds and operating system distributions. Containers allow agile application creation and deployment. Containers also allow continuous development, integration and deployment.

Containers can be layered on top of each other and are quick to initialize and terminate and thus work well for load balancing and redundancy of small, stateless services. Docker is the most common container support implementation. Containers allow developers to bundle up everything needed to run an application and push out the container to their infrastructure. Containers are homogeneous bundles that offer the same environment across any infrastructure, ranging from a laptop to production platforms. Whatever libraries and services are running, everything is within the container. However, services running in containers are not very secure or isolated. Therefore, improvements are desirable.

### SUMMARY

In a first aspect, a method of securing containers is disclosed. The method includes configuring service access points within clusters as secure endpoints; associating services with secure identities to constrain which communities-of-interest can reach which services; and wherein each cluster is cryptographically isolated such that no information will leak in or out of the cluster through an associated network.

In a second aspect, a system operating on an apparatus having a memory and a processor coupled to the memory is disclosed. The system includes service access points within clusters of containers configured as secure endpoints to handle all communications into and out of the cluster. The system also includes services within the clusters having secure identities to constrain which communities of interest can reach which services. Each cluster is cryptographically isolated such that no information will leak in or out of the cluster through an associated network.

In a third aspect, a computer program product is disclosed comprising a non-transitory computer readable medium comprising instructions which, when executed by a processor of a computer system, cause the processor to perform the steps of: configuring service access points within clusters of containers as secure endpoints, which handle all communications into and out of the cluster; and associating services within the clusters with secure identities to constrain which communities-of-interest can reach which services; wherein each cluster is cryptographically isolated such that no information will leak in or out of the cluster through an associated network.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram illustrating an encrypted enclave of virtual machines organized into communities-of-interest, according to one embodiment of the present invention;

FIG. 2 is a is a block diagram illustrating a network implementing communities-of-interest, according to one embodiment of the present invention;

FIG. 3 is a block diagram illustrating an enclave included in the network of FIG. 2;

FIG. 4 is a schematic diagram of a Kubernetes system, according to one example embodiment of the present invention;

FIG. 5 is a schematic diagram of a Kubernetes system being used by two user groups running a secured system, according to one example embodiment of the present invention;

FIG. 6 is a schematic diagram illustrating details for the Kubernetes workers of FIG. 5, according to one example embodiment of the present invention;

FIG. 7 is a flow diagram of a method of securing containers, according to one example embodiment of the present invention.

FIG. 8 is a block diagram illustrating a computer network, according to one example embodiment of the present invention;

FIG. 9 is a block diagram illustrating a computer system, according to one example embodiment of the present invention;

FIG. 10A is a block diagram illustrating a server hosting an emulated software environment for virtualization, according to one example embodiment of the present invention;

FIG. 10B is a block diagram illustrating a server hosting an emulated hardware environment, according to one example embodiment of the present invention; and

### DETAILED DESCRIPTION

In general, the present disclosure relates to securing containers. Kubernetes provides a way for a cluster of machines to provide multiple distinct services but are not cryptographically isolated. Unisys Stealth® Software (“Stealth”) provides a strong guarantee of cryptographic isolation in a general purpose network. By configuring service access points in Kubernetes as Stealth endpoints, Kubernetes services can be associates with Stealth identities and constrain which communities-of-interest can reach which services. By cryptographically isolating each Kubernetes cluster, no information will leak in or out of the cluster through the associated network. Thus, Stealth can secure the Kubernetes containers.

Stealth reduces attack surfaces in an environment by creating dynamic, identity-driven microsegments called communities-of-interest. Micro segmentation is a security strategy that segments a network into smaller elements and manages them with IT security policies. By establishing secure community-of-interest, Stealth separates trusted systems, users and data from the untrusted. It further reduces attack surfaces by encrypting all communication between Stealth protected assets and cloaking the assets from unauthorized users. Micro segmentation divides a physical network into multiple logical micro-segments. Only the resources within the micro segment can see and access one another.

For example, virtual machines executing on one or more servers may each be assigned one or more communities-of-interest. The communities-of-interest may allow an administrator to create logical organizations of virtual machines. A community-of-interest may be defined by a role of the virtual machines in the community-of-interest.

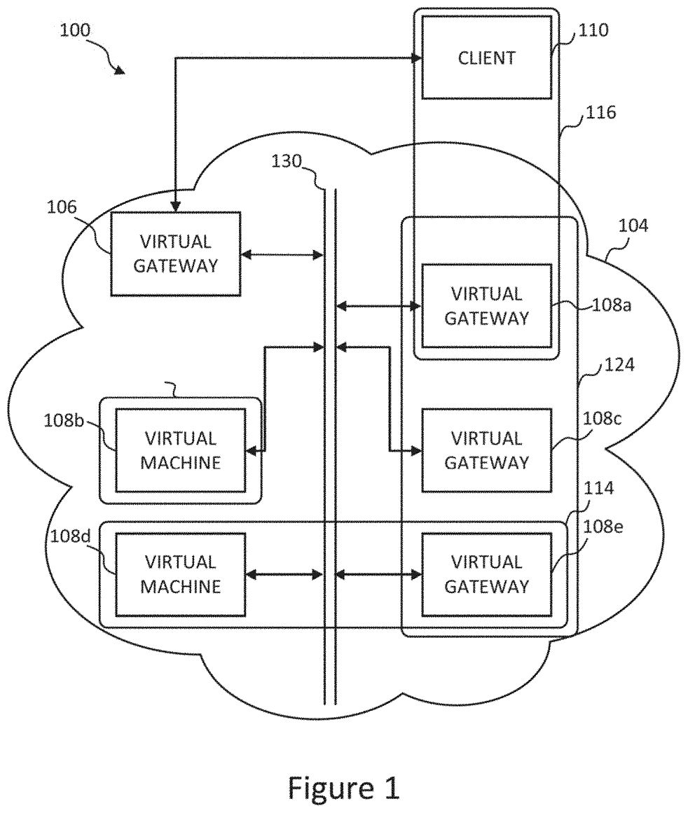

Messages or communications within a community-of-interest are encrypted with a key corresponding to the community-of-interest. In this fashion, messages or communications are cryptographically isolated. FIG. 1 is a block diagram illustrating an encrypted enclave of virtual machines organized into communities-of-interest according to one example embodiment of the present disclosure. A network 100 may include a network bus 130 serving an enclave 104. The bus 130 may couple virtual machines 108a-e within the enclave 104. Each of the virtual machines 108a-3 may communicate through encrypted communications carried on the bus 130. A virtual gateway 106 may be coupled to the bus 130 to provide communications from the enclave 104 to external devices, such as a client 110 and/or other public networks, such as the Internet. The client 110 may be a remoted device, such as a personal computer or mobile device. The client 110 may be connected to the virtual gateway 106 through a secured tunnel, such that the communications between the client 110 and the virtual gateway 106 are encrypted similar to the encrypted communications on the bus 130.

The virtual machines 108a-e may be assigned to one or more communities-of-interest. For example, the virtual machines 108a, 108c, and 108e may be assigned to community-of-interest 124. Virtual machines 108d and 108e may be assigned to community-of-interest 114. And, virtual machine 108b may be assigned to community-of-interest 122. And, the virtual machine 108a and the client 110 may be assigned community-of-interest 116.

A virtual machine 108e may be instructed to transmit a message to the virtual machine 108a. For example, software executing on the virtual machine 108e may request data from a database server executing on the virtual machine 108e may request data from a database server executing on the virtual machine 108a. When the virtual machine 108e receives the message destined for the virtual machine 108a, the virtual machine 108e may identify a community-of-interest in common between virtual machine 108e and virtual machine 108a. The community-of-interest 124 may be identified and a key associated with COI 124 may be used to encrypt the message.

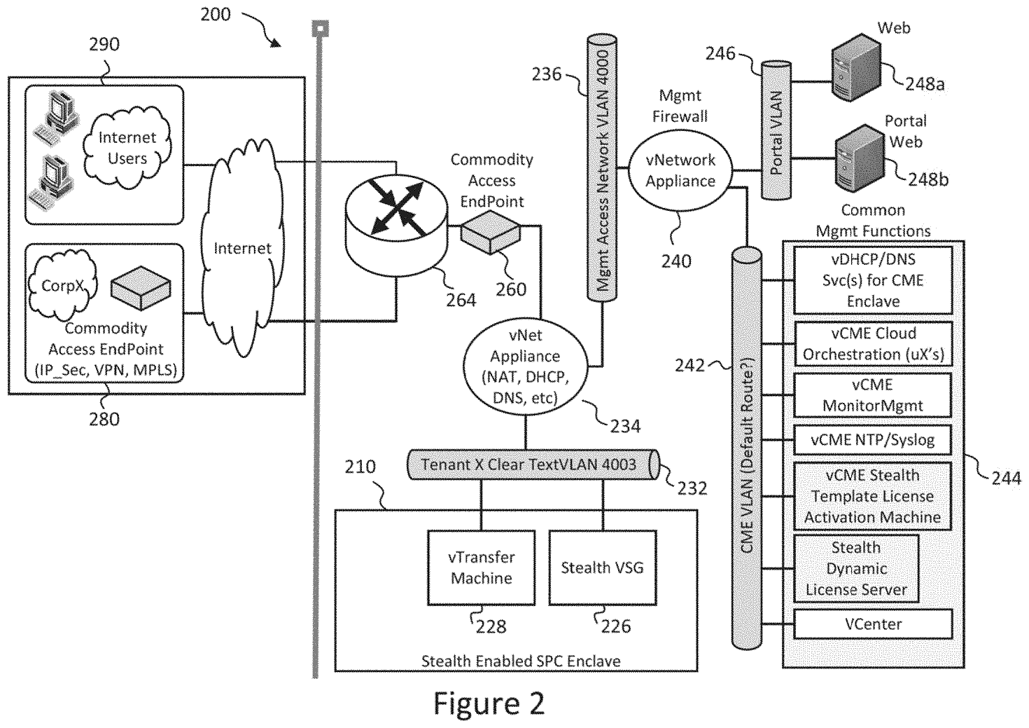

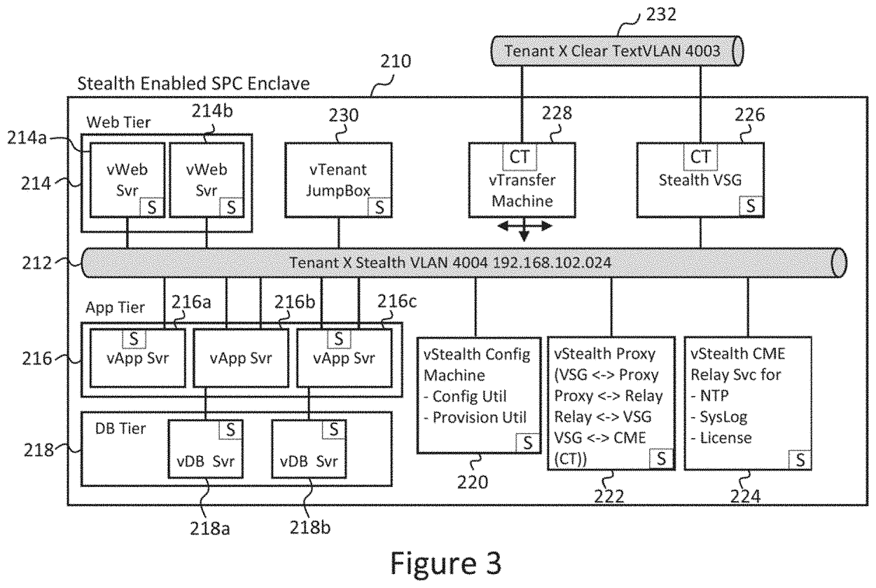

The community-of-interest organization of virtual machines may be implemented in a computer network to provide cryptographic isolation of virtual machines. FIGS. 2 and 3 are block diagrams illustrating a network implementing communities-of-interest according to one embodiment of the disclosure. A network 200 may include an enclave 210. According to one embodiment, the enclave 210 may belong to a single tenant of the network 200. In other embodiments, the enclave 210 may be shared between tenants.

Communities-of-interest may be configured for a web tier 214, an application tier 216, and a database tier 218. The web tier 214 may include a number of web servers 214a-b, the application tier 216 may include a number of application servers 216a-c, and the database tier 218 may include a number of database servers 218a-b. Each of the servers 214a-b, 216a-c, and 218a-b may be a virtual server executing within a virtual machine. Additional communities-of-interest may be defined for infrastructure functions, such as an administrator community-of-interest key COI, a relay COI, an application tier management COI, a database tier management COI, and a jumpbox management COI. The enclave 210 may also include a jumpbox 230, a transfer machine 228, a virtual gateway 226, a relay 224, a proxy 222, and a configuration device 220, which may also be executing in virtual machines.

Membership of the virtual machines in individual COIs are shown as numbered circles. Each circle may represent a different COI such as the web tier COI. For example, a web tier COI may include the servers 214a-b, the jumpbox 230, and the virtual gateway 226. According to one embodiment, only virtual machines that share a common COI may communicate. When a first virtual machine initiates communication with a second virtual machine, the first virtual machine may search for a common COI between the first and the second virtual machine. If found, a cryptographic session key may be created that is encrypted with a key associated with the common COI. Thus, only a virtual machine that shares the COI key may decrypt the session key. All communication between the two virtual machines may be encrypted and decrypted with the session key. Messages within the enclave 210 may be isolated from the rest of the network 200, because the messages are encrypted with keys that are not available to the rest of the network 200.

For example, a web server virtual machine 214a may be able to communicate with another web server virtual machine 214b, because the virtual machines 214a-b have the web tier COI in common. They may also be able to communicate with application server virtual machines 316a-c, because the machines 214a-b and 216a-c have the application tier COI in common.

Each of the devices within the enclave 210 may be coupled to a bus 212. When a device within the enclave 210 communicates with devices outside the enclave 210, then messages may be handled by the virtual gateway 226, which may be coupled to an unencrypted network 232. According to one embodiment, the virtual gateway 226 may encrypt and/or decrypt messages between the enclave 210 and the unencrypted network 232. The network 232 may couple the enclave 210 to other network appliances 234, such as network address translation (NAT) devices, dynamic host control protocol (DHCP) devices, domain name service (DNS) devices, and the like. The other network appliances 234 may also be executing in virtual machines.

Access to the enclave 210 may be controlled by the virtual gateway 226. Messages passing through the gateway from the unencrypted, or clear-text, network 222 to the enclave 210 may be encrypted and messages in the other direction may be decrypted by the gateway 226. According to one embodiment, messages within the enclave 210 may only be transmitted to a virtual machine that has a COI in common with the gateway 226. Furthermore, the gateway 226 may be configured to filter messages for a COI. The filter may allow an administrator to restrict access based on a message's source and/or destination address and/or port. The enclave 210 may also be isolated from other enclaves (not shown) in the network 200, because only a virtual machine having a common COI with the gateway 226 may communicate outside of the enclave 310.

For example, the web servers 214a-b may be able to communicate through the gateway 226, because the web servers 214a-b share the web tier COI with the gateway 226. In another example, the application servers 216a-c and the database servers 218a-b may have restricted access through the gateway 226, because the gateway 226 may filter messages transmitted in the application COI and the database COI to only provide access to management devices 244.

Referring back to the concept of containers, Docker is a container platform for building, configuring and distributing Docker containers. It has a simple load balancing mechanism called a swarm, which is a group of functionally identical containers. Kubernetes orchestrates groups of Docker containers. A typical Kubernetes environment is composed of a collection of machines called nodes. These machines are grouped into sets called clusters that include, among other things, ingress and egress nodes that act as gateways to forward traffic sent into and out of the cluster.

Kubernetes manages Docker and introduces the idea of pods. A pod is a collection of containers deployed together and that trust one another. One or more types of pods may cooperate to implement a service, such as a web service or a web server. If traffic to a container is high, Kubernetes is able to load balance and distribute the network traffic so that the deployment is stable. The pods are ephemeral in that Kubernetes may spin them up, or down in response to need. The contents of a pod are always collocated on a host, but they may share a host with other pods. The shared context of a pod is a set of namespaces, cgroups and potentially other facets of isolation—the same things that isolate a Docker container. Within a pod's context, the individual applications may have further sub-isolations applied.

Containers within a pod share an IP address and port space and can find each other via local host. They can also communicate with each other using standard inter-process communications like System V semaphores or POSIX shared memory. Containers in different pods have distinct IP address and cannot communicate by IPC without special configuration.

A Kubernetes cluster is a set of operating system instances. Each operating system instance could be a physical machine but is normally a virtual machine. The virtual machine instances are called nodes and run multiple containers. Each node has its own basic configuration, similar to a virtual machine. Kubernetes can expose a container using its own IP address. A virtual machine becomes a node by joining a Kubernetes cluster. Each node can have a set of arbitrary labels associated with it. The master node, or nodes for redundancy, have .conf files in /etc/Kubernetes and .yami files in /etc/Kubernetes/manifests. There is also an etcd key/value stoe with the desired configuration in it. Access to the configuration is via a RESTful interface to Kubernetes. The kubectl command line tool can be used to access it, and the Stealth configuration lives in etcd as well in custom resource definitions.

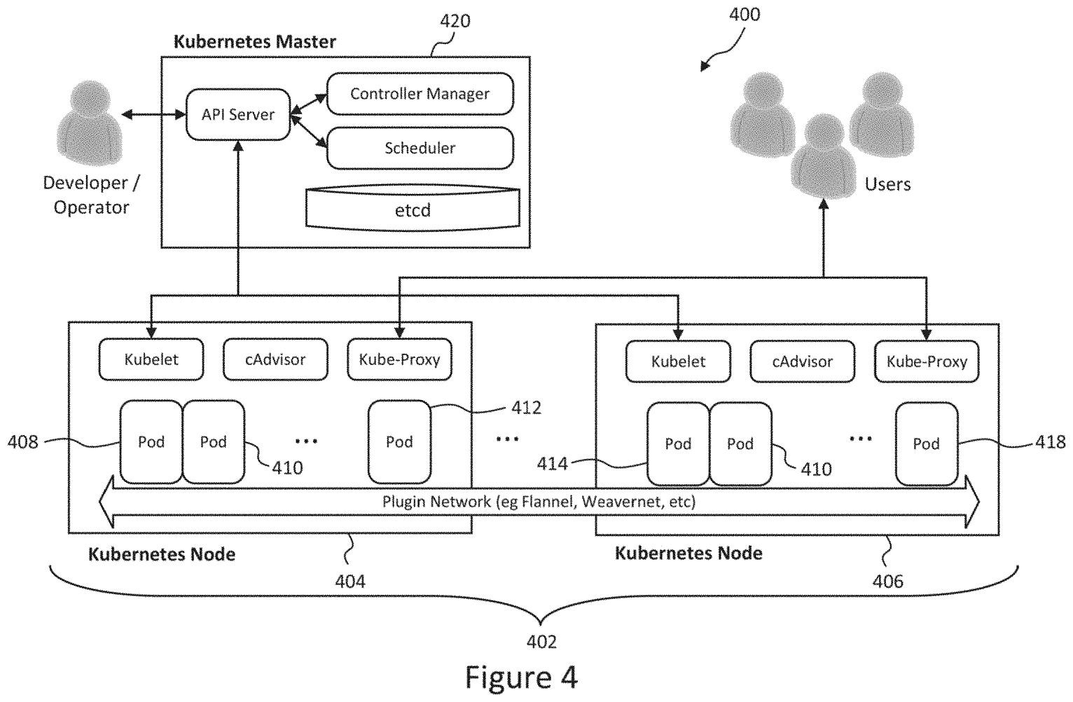

FIG. 4 illustrates the parts of Kubernetes 400. A cluster 402 is a collection of nodes 404, 406. Node 404 includes multiple pods 408, 410, 412. Node 406 also includes multiple pods 414, 416, 418. A service can run on a collection of pods. A Kubernetes master 420 manages and controls the nodes 404, 406.

To implement Stealth within Kubernetes, each node 404, 406 has a Stealth endpoint installed. In general, communities-of-interest are utilized. Endpoints within a community-of-interest can only communicate with other endpoints within the same community-of-interest. Some nodes are dedicated to incoming and outgoing messages. They translate between the cluster community-of-interest and external communities-of-interest. These nodes are distinguished by having specific pods loaded on them, including Stealth controller pods and Stealth drivers. Within the cluster, every message or communication uses the cluster community-of-interest. Services are the endpoints that can support Stealth. Each service must have a unique IP address in order to support Stealth. As discussed herein, Kubernetes can assign unique IP addresses to containers.

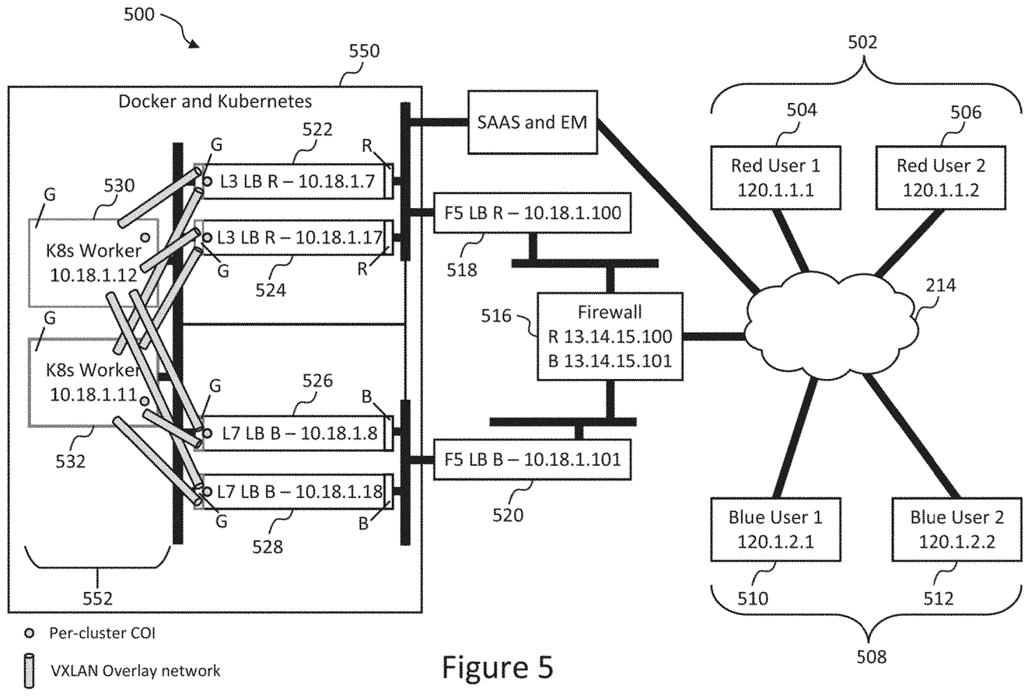

FIG. 5 is an illustration of a secured container system 500 utilizing Kubernetes with Stealth. The system 500 includes a red community-of-interest 502, which has a red user 1 504 and a red user 2 506. The system 500 also includes a blue community-of-interest 508, which has a blue user 1 510 and a blue user 2 512. The red community-of-interest 502 and the blue community-of-interest 508 are both connected to common network services 514, which may or may not be implemented over the cloud. The red users 504, 506 of the red community-of-interest 502 can only communicate with and see each other, even though they are using common network services 514. The messages or communications within the red community-of-interest 502 are encrypted with a key associated with only the red community-of-interest 502. Thus, for example, the users 510, 512 of the blue community-of-interest 508 would not have the key for the red community-of-interest 502 and thus could not decrypt the communications.

Likewise, the blue users 510, 512 of the blue community-of-interest 508 can only communicate and see each other, even though they are using the same common network services 514. The messages or communications within the blue community-of-interest 508 are encrypted with a key associated with only the blue community-of-interest 508. Thus, for example, the users of the 504, 506 of the red community-of-interest 502 would not have the key for the blue community-of-interest 508 and thus could not decrypt the communications.

Communications leaving the common network services go through a firewall 516 and into a respective load balancers 518, 520. Communications form the red community-of-interest 502 go to load balancer red 518, and communications from the blue community-of-interest 508 go to load balance blue 520. The communications enter into the Kubernetes cluster 550, such as system 400 of FIG. 4.

Within the Kubernetes cluster 550, the communications from the red load balancer 518 go into a secure endpoints 522, 524, such as a Stealth endpoint, and are translated from a red community-of-interest 502 to a green community-of-interest 552 and go into the Kubernetes workers 530, 532, which are part of the green community-of-interest 552, where they can be operated on. The green community-of-interest 552 are services within the clusters having secure identities to constrain which communities-of-interest can reach which services. The secure endpoints 522, 524 are a Stealth controller node within the cluster 550. The secure endpoints 522, 524 handle all communications in and out of the cluster 550.

Likewise, communications from the blue load balancer 520 go into secure endpoints 526, 528 and are translated from a blue community-of-interest 508 to the green community-of-interest 552 and go into the Kubernetes workers 530, 532 where they can be operated on. Within the green community-of-interest 552, all communications are encrypted with a key specific to the green community-of-interest 552. Results of the operations within the green community-of-interest 552 can flow back to the red users 504, 506 and blue users 510, 512 in a likewise fashion.

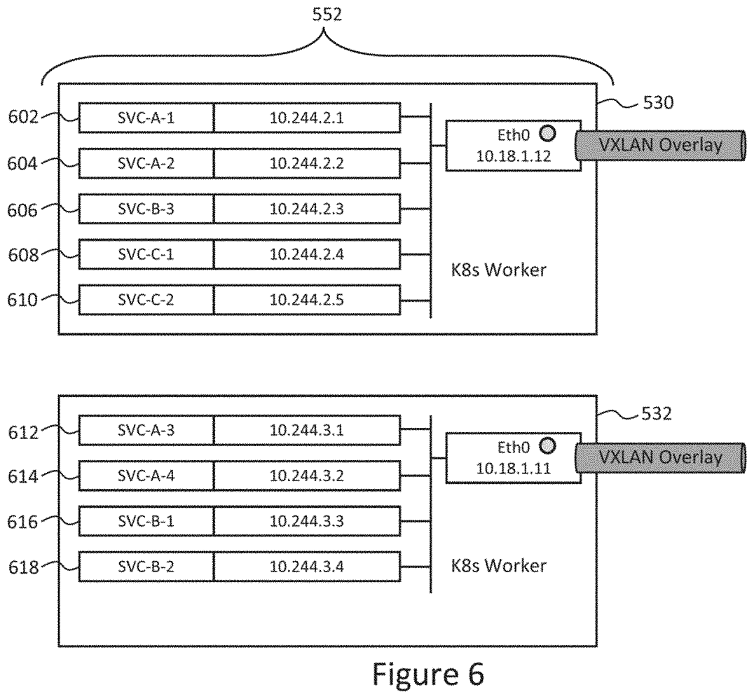

FIG. 6 is a schematic diagram illustrating more details for the Kubernetes workers 530, 532 of FIG. 5. The first worker 530 is running Service A-1 602 and Service A-2 604 being used by the red community-of-interest 502 and Service B-3 606, Service C-1 608 and Service C-2 610 being used by the blue community-of-interest 508. The second worker 532 is running Service A-3 612 and Service A-4 614 being used by the red community-of-interest 502 and Service B-1 616 and Service B-2 618 being used by the blue community-of-interest 508. The first worker 530 and second worker 532 are in the green community-of interest 552.

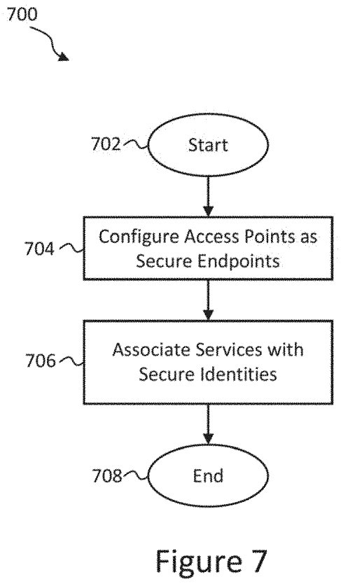

FIG. 7 is a flow diagram of a method 700 of securing containers. The method starts at 702. At 704, access points are configured as secure endpoints. At 706, services are associated with secure identities and the method ends at 708. As such, each cluster is cryptographically isolated such that no information will leak in or out of the cluster through an associated network.

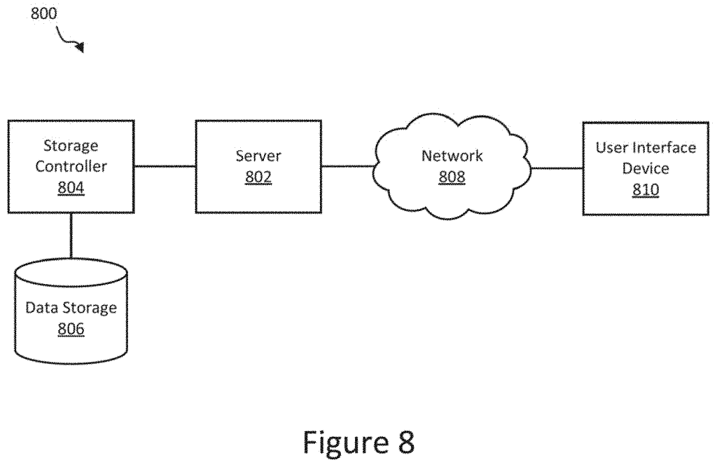

FIG. 8 illustrates one embodiment of a system 800 for an information system, which may host virtual machines. The system 800 may include a server 802, a data storage device 806, a network 808, and a user interface device 810. The server 802 may be a dedicated server or one server in a cloud computing system. The server 802 may also be a hypervisor-based system executing one or more guest partitions. The user interface device 810 may be, for example, a mobile device operated by a tenant administrator. In a further embodiment, the system 800 may include a storage controller 804, or storage server configured to manage data communications between the data storage device 806 and the server 802 or other components in communication with the network 808. In an alternative, embodiment, the storage controller 804 may be coupled to the network 808.

In one embodiment, the user interface device 810 is referred to broadly and is intended to encompass a suitable processor-based device such as a desktop computer, a laptop computer, a personal digital assistant (PDA) or tablet computer, a smartphone or other a mobile communication device having access to the network 808. The user interface device 810 may be used to access a web service executing on the server 802. When the device 810 is a mobile device, sensors (not shown), such as a camera or accelerometer, may be embedded in the device 810. When she device 810 is a desktop computer the sensors may be embedded in an attachment (not shown) to the device 810. In a further embodiment, the user interface device 810 may access the Internet or other wide area or local area network to access a web application or web service hosted by the server 802 and provide a user interface for enabling a user to enter or receive information.

The network 808 may facilitate communications of data, such as dynamic license request messages, between the server 802 and the user interface device 810. The network 808 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 810 accesses the server 802 through an intermediate sever (not shown). For example, in a cloud application the user interface device 810 may access an application server. The application server may fulfill requests from the user interface device 810 by accessing a database management system (DBMS). In this embodiment, the user interface device 810 may be a computer or phone executing a Java application making requests to a JBOSS server executing on a Linux server, which fulfills the requests by accessing a relational database management system (RDMS) on a mainframe server.

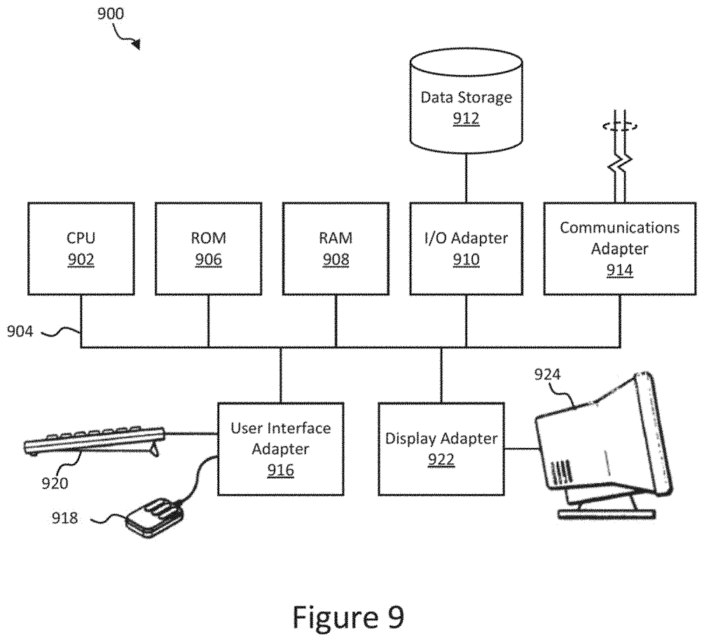

FIG. 9 illustrates a computer system 900 adapted according to certain embodiments of the server 802 and/or the user interface device 810. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the operations as described herein. The CPU 902 may execute the various logical instructions according to the present embodiments.

The computer system 900 also may include random access memory (RAM) 908, which may be synchronous RAM (SRAM), dynamic RAM (DRAM), synchronous dynamic RAM (SDRAM), or the like. The computer system 900 may utilize RAM 908 to store the various data structures used by a software application. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data, and both the RAM 908 and the ROM 906 may be randomly accessed.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may couple one or more storage devices 912, such as one or more of a hard drive, a solid state storage device, a flash drive, a compact disc (CD) drive, a floppy disk drive, and a tape drive, to the computer system 900. According to one embodiment, the data storage 912 may be a separate server coupled to the computer system 900 through a network connection to the I/O adapter 910. The communications adapter 914 may be adapted to couple the computer system 900 to the network 908, which may be one or more of a LAN, WAN, and/or the Internet. The communications adapter 914 may also be adapted to couple the computer system 900 to other networks such as a global positioning system (GPS) or a Bluetooth network. The user interface adapter 916 couples user input devices, such as a keyboard 920, a pointing device 918, and/or a touch screen (not shown) to the computer system 900. The keyboard 920 may be an on-screen keyboard displayed on a touch panel. Additional devices (not shown) such as a camera, microphone, video camera, accelerometer, compass, and or gyroscope may be coupled to the user interface adapter 916. The display adapter 922 may be driven by the CPU 902 to control the display on the display device 924. Any of the devices 902-922 may be physical and/or logical.

The applications of the present disclosure are not limited to the architecture of computer system 900. Rather the computer system 900 is provided as an example of one type of computing device that may be adapted to perform the functions of a server 802 and/or the user interface device 810. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 900 may be virtualized for access by multiple users and/or applications.

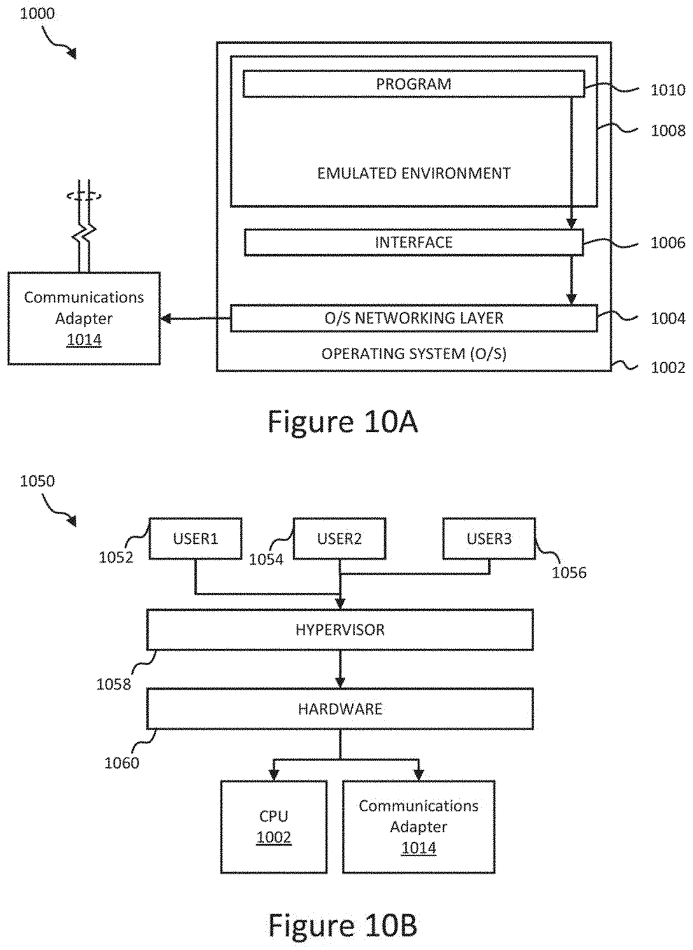

FIG. 10A is a block diagram illustrating a server hosting an emulated software environment for virtualization according to one embodiment of the disclosure. An operating system 1002 executing on a server includes drivers for accessing hardware components, such as a networking layer 1004 for accessing the communications adapter 914. The operating system 1002 may be, for example, Linux. An emulated environment 1008 in the operating system 1002 executes a program 1010, such as CPCommOS. The program 1010 accesses the networking layer 1004 of the operating system 1002 through a non-emulated interface 1006, such as XNIOP. The non-emulated interface 1006 translates requests from the program 1010 executing in the emulated environment 1008 for the networking layer 1004 of the operating system 1002.

In another example, hardware in a computer system may be virtualized through a hypervisor. FIG. 10B is a block diagram illustrating a server hosting an emulated hardware environment according to one embodiment of the disclosure. Users 1052, 1054, 1056 may access the hardware 1060 through a hypervisor 1058. The hypervisor 1058 may be integrated with the hardware 1060 to provide virtualization of the hardware 1060 without an operating system, such as in the configuration illustrated in FIG. 10A. The hypervisor 1058 may provide access to the hardware 1060, including the CPU 902 and the communications adaptor 914.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and bin-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described, in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. A method of securing containers within clusters, the method comprising:
configuring service access points within clusters of containers as secure endpoints, which handle all communications into and out of the cluster; and
associating services within the clusters with secure identities to constrain which communities-of-interest can reach which services;
wherein each cluster is cryptographically isolated such that no information will leak in or out of the cluster through an associated network.

2. The method of claim 1, further comprising encrypting communications within communities of interest with a key associated with the communities of interest.

3. The method of claim 1, wherein associating includes communities of interest configured for a web tier, an application tier or a database tier.

4. The method of claim 1, configurating service access points includes configuring a service access point as a node within a cluster.

5. The method of claim 1, wherein associating services includes associating services within the clusters as a community of interest.

6. The method of claim 1, further comprising translating by the secure endpoints between communities of interest outside the cluster and communities of interest within the cluster.

7. A system operating on an apparatus having a memory and a processor coupled to the memory, system comprising:
service access points within clusters of containers configured as secure endpoints to handle all communications into and out of the cluster; and
services within the clusters having secure identities to constrain which communities of interest can reach which services;
wherein each duster is cryptographically isolated such that no information will leak in or out of the cluster through an associated network.

8. The system of claim 7, further wherein the secure endpoints encrypt, communications within communities of interest with a key associated with the communities of interest.

9. The system of claim 7, wherein communities of interest can be configured for a web tier, an application tier or a database tier.

10. The system of claim 7, wherein a service access point is a node within a cluster.

11. The system of claim 7, wherein services within the clusters are part of a community of interest.

12. The system of claim 7, wherein he secure endpoints translate between communities of interest outside the cluster and communities of interest within the cluster.

13. A computer program product, comprising:
a non-transitory computer readable medium comprising instructions which, when executed by a processor of a computer system, cause the processor to perform the steps of:
configuring service access points within clusters of containers as secure endpoints, which handle all communications into and out of the cluster; and
associating services within the clusters with secure identities to constrain which communities-of-interest can reach which services;
wherein each cluster is cryptographically isolated such that no information will leak in or out of the cluster through an associated network.

14. The computer program product of claim 13, further comprising encrypting communications within communities of interest with a key associated with the communities of interest.

15. The computer program product of claim 13, wherein associating includes communities of interest configured for a web tier, an application tier or a database tier.

16. The computer program product of claim 13, configurating service access points includes configuring a service access point as a node within a cluster.

17. The computer program product of claim 13, wherein associating services includes associating services within the clusters as a community of interest.

18. The computer program product of claim 13, further comprising translating by the secure endpoints between communities of interest outside the cluster and communities of interest within the cluster.
